(19) United States
(12) Patent Application Publication
(10) Pub. No.: US 2003/0117446 A1
(43) Pub. Date: Jun. 26, 2003

(54) System and method for processing transaction information

(75) Inventors: Rosanne Esposito-Ross, Issaquah, WA (US); Scott Humanek, Seattle, WA (US); Robert Silten, Branford, CT (US); Patricia West, Monroe, WA (US); Marcella Shanks, Seattle, WA (US); Bernardina Legin, Kent, WA (US); Richard Rosettie, Carefree, AZ (US); Anne Schmidt, New Albany, IN (US); Peter Caleb Fearey, Bainbridge Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Expeditors International of Washington Inc.

(21) Appl. No.: 10/321,865

(22) Filed: Dec. 17, 2002

Related U.S. Application Data
(60) Provisional application No. 60/343,361, filed on Dec. 21, 2001.
(60) Provisional application No. 60/343,499, filed on Dec. 21, 2001.

(51) Int. Cl. G09G 5/00

(52) U.S. Cl. 345/810

(57) ABSTRACT

A system and method for facilitating the management of transactions between parties in a networked environment are provided. A transaction processing system can include one or more buyer computing devices, one or more seller computing devices, one or more shipping computing devices and a central processing system. The central processing system maintains communications with the various components of the transaction processing system to facilitate the collection and management of product data. Additionally the central processing system facilitates the completion of transaction negotiations and the generation of documentation required to complete the transaction between buyers, sellers and shipping agents.

### CROSS-REFERENCE TO RELATED APPLICATIONS

This application claims the benefit of U.S. Provisional Application No. 60/343,361, filed Dec. 21, 2001, and entitled SYSTEM AND METHOD FOR INTEGRATING SHIPPING DOCUMENTATION VIA A NETWORK. This application also claims the benefit of U.S. Provisional Application No. 60/343,499, filed Dec. 21, 2001, and entitled SYSTEM AND METHOD FOR INTEGRATING SHIPPING DOCUMENTATION VIA A NETWORK. U.S. Provisional Application Nos. 60/343,361 and 60/343,499 are hereby incorporated by reference.

### FIELD OF THE INVENTION

In general, the present invention relates to computer networks and software, and in particular, to a system and method for facilitating transactions, and the exchange of transaction documentation, in a networked environment.

### BACKGROUND OF THE INVENTION

Generally described, transactions, such as international commerce transactions, can involve the execution of a number of steps by a number of parties to complete one or more transactions. In an example international transaction, a buyer can place a transaction request from a seller that requires an identification of parties available to complete the desired transaction, an exchange of product/service information, an agreement of transaction terms, a generation of documents required to complete the transaction and/or an agreement of shipping terms. In a traditional embodiment, a buyer can directly contact one or more involved parties (e.g., sellers, shippers, carriers, insurers, financiers, etc.) to discuss the terms of a potential transaction and potentially come to an agreement. However, the traditional approach can become deficient in a variety of situations. For example, in the event that the parties are limited by language, the exchange of information and/or communication between the parties can be difficult. Additionally, if the parties are on substantially different time zones, direct communication may become difficult. Further, in the event the parties have repetitive transactions, there is the potential that a number of the actions required to complete a transaction are redundantly executed for each transaction.

One approach to mitigate the problems associated with international transaction includes the use of computer-based interface services, facilitated through personal computers, mobile phones, and/or personal digital assistants (“PDA”), provided over a communication network connection, such as the Internet. Although traditional computer-based interfaces can assist in exchanging limited amounts of information, the traditional computer-based interface can be deficient for a variety of reasons. In one aspect, the traditional computer-based interface does not allow for the management and independent generation of documents requiring a signature by one or more parties. For example, there are a number of international treaties, such as the North American Free Trade Agreement (“NAFTA”) that require transaction documents that include the signature of the parties. Current computer-based interface systems often generate generic documents that still must be signed and directly transmitted to both parties. This approach increases the time required to complete a transaction and can become more difficult with language/time zones barriers. In another aspect, many of the traditional computer-based interfaces do not provide a manner in which to manage multiple sellers' product listings such that an individual buyer can query the seller's inventories through a manipulation of a single interface. Likewise, the traditional computer-based interface does not provide a manner in which a seller can modify aspects of its product data stored by the computer-based interactive service. In still a further aspect, the traditional commercial interface does not provide a manner in which data related to a previous aspect of a transaction, such as an agreement of terms, is easily transferred to a separate aspect of the transaction, such as shipping arrangements, without requiring redundant and potentially erroneous data entry.

Based on the above-described deficiencies associated with the conventional art, there exists a need for a system and method for facilitating transactions and processing transaction information between a number of parties in a network environment.

### SUMMARY OF THE INVENTION

A system and method for facilitating the management of transactions between parties in a networked environment are provided. A transaction processing system can include one or more buyer computing devices, one or more seller computing devices, one or more shipping computing devices and a central processing system. The central processing system maintains communications with the various components of the transaction processing system to facilitate the collection and management of product data. Additionally the central processing system facilitates the completion of transaction negotiations and the generation of documentation required to complete the transaction between buyers, sellers and shipping agents.

In accordance with an aspect of the present invention, a method for managing data corresponding to transactions is provided. The method may be implemented in a system having a graphical user interface including a display and user interface selection device. In accordance with the method a central processing system obtains product item data corresponding to one or more product items. The product item data includes an identification of the product item, the source of the product item and at least one attribute of the product item. The central processing system generates on the display the product item data. The central system then obtains an action item request corresponding to the product item data and executes the specified action item. The central processing system displays the results of the executed action item on the display.

In accordance with another aspect of the present invention, a method for processing transactions is provided. A central system obtains a request to complete a transaction and obtains one or more document templates corresponding to the requested transaction. The central system processes the document templates and generates one or more documents from the processing document templates.

In accordance with a further aspect of the present invention, a system for facilitating the processing of transaction is provided. The system includes a buyer computing device operable to generate transaction requests. The system also includes a central processing system in communication with the buyer computing device and operable to process the transaction request from the buyer computing device. The system further includes a seller computing device in communication with the central processing system and operable to provide transaction information to the central processing system. The central processing system is further operable to manage the transaction information to process the transaction request.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a representative portion of the Internet;

FIG. 2 is a block diagram of a transaction processing system including a number of seller computing devices, a number of buyer computing devices, a central processing system, and a shipper computing device, a number of additional third-party service provider computing devices formed in accordance with the present invention;

FIG. 3 is a block diagram depicting an illustrative architecture for a buyer computing device in accordance with the present invention;

FIG. 4 is a block diagram depicting an illustrative architecture for a seller computing device in accordance with the present invention;

FIG. 5 is a block diagram depicting an illustrative architecture for a central processing system in accordance with the present invention;

FIG. 6 is a block diagram of the transaction processing system of FIG. 2 illustrating the management and transmission of seller product data by a central processing system in accordance with the present invention;

FIG. 7 is a block diagram illustrative of a screen display generated by a computing device for facilitating the management of seller product data in accordance with the present invention;

FIG. 8 is a block diagram illustrative of a screen display generated by a computing device for facilitating the management of seller product data in accordance with the present invention;

FIG. 9 is a block diagram illustrative of a screen display generated by a computing device for facilitating the management of data in accordance with the present invention;

FIG. 10 is a block diagram illustrative of a screen display generated by a computing device for facilitating the transmission of a query of seller product data in accordance with the present invention;

FIG. 11 is a block diagram illustrative of a screen display generated by a computing device for facilitating action item data stored in the transaction processing system by manipulating multiple data fields on the user interface in accordance with the present invention;

FIG. 12 is a block diagram illustrative of a screen display generated by a computing device for tracking the modification of data in accordance with the present invention;

FIGS. 13A and 13B are block diagrams of the transaction processing system of FIG. 2 illustrating the management and transmission of transaction documentation by a central processing system in accordance with the present invention;

FIG. 14 is a block diagram illustrative of a screen display generated by a computing device for generating transaction documentation, including signature data, in accordance with the present invention;

FIG. 15 is a block diagram of the international transaction processing system of FIG. 2 illustrating the coordination of shipping specifications by a central processing system in accordance with the present invention;

FIG. 16 is a block diagram illustrative of a screen display generated by a computing device for obtaining associated party information in accordance with the present invention;

FIG. 17 is a flow diagram illustrative of a transaction processing routine implemented by a central processing system in accordance with the present invention;

FIG. 18 is a flow diagram illustrative of a shipping request processing routine implemented by a central processing system in accordance with the present invention;

FIG. 19 is a block diagram illustrative of a screen display generated by a computing device to obtain product shipping information for a transaction in accordance with the present invention;

FIG. 20 is a block diagram illustrative of a screen display generated by a computing device to obtain product carrier information in accordance with the present invention;

FIG. 21 is a block diagram of the international transaction processing system of FIG. 2 illustrating the coordination of a threat profile for one or more product suppliers by the central processing system in accordance with the present invention.

### DETAILED DESCRIPTION OF THE PREFERRED EMBODIMENT

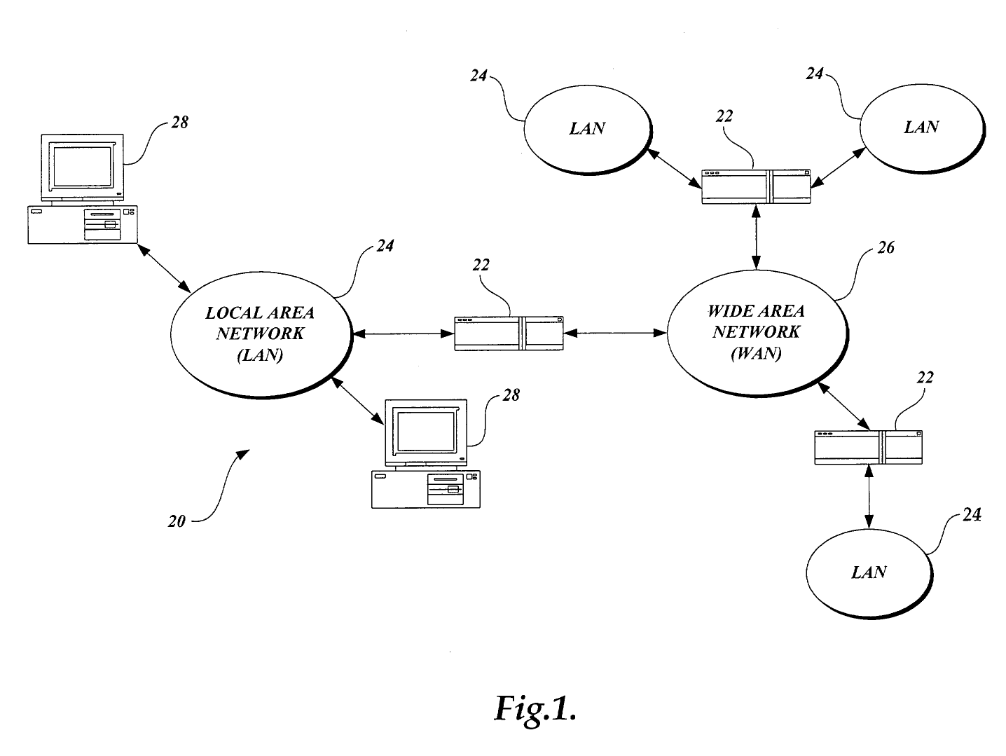

As described above, aspects of the present invention are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at “WWW sites” or “Web sites” throughout the Internet. Other interactive hypertext environments may include proprietary environments such as those provided in America Online or other online service providers, as well as the “wireless Web” provided by various wireless networking providers, especially those in the cellular phone industry. It will be appreciated that the present invention could apply in any such interactive hypertext environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents. Imbedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the exact location of the linked document on a server connected to the Internet and describes the document. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a graphical user interface to the WWW. Upon request from the remote access user via the web browser, the web browser locates and retrieves the desired hypertext document from the appropriate web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the web server, such as JAVA applets, for execution on the client computer.

The present application is directed toward a system and method for facilitating transactions between a number of parties involved in a transaction, such as buyers, sellers, shippers, carriers, financiers, insurers, government officials, and the like. More specifically, the present invention is directed toward a system and method for integrating the generation and exchange of transaction documentation in a networked environment. Although the present invention will be described in regards to an implementation with an illustrative transaction processing system, one skilled in the relevant art will appreciate that the disclosed transaction processing system and the disclosed embodiments are illustrative in nature and should not be construed as limiting.

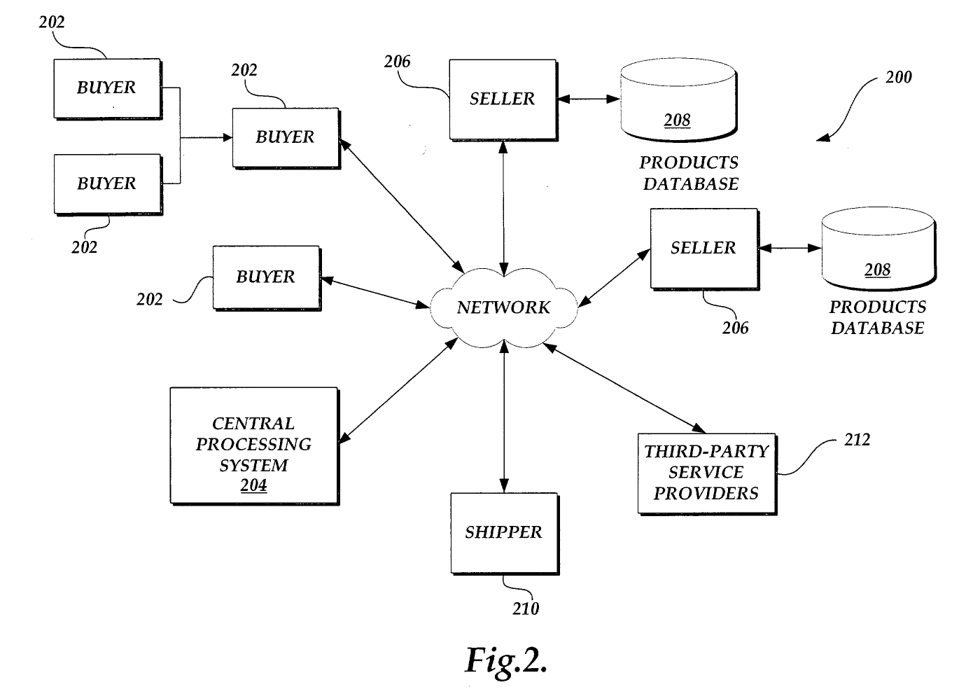

Referring now to FIG. 2, an interactive transaction processing system 200 for facilitating and processing transactions between a number of parties involved in a product transaction will be described. In an illustrative embodiment of the present invention, the transaction processing system 200 can be a private, subscriber-based system allowing a number of parties to interact via a common communication network, such as the Internet 20. Alternatively, the transaction processing system 200 can be a public system allowing access to any number of parties via a communication network.

As illustrated in FIG. 2, the transaction processing system 200 includes a number of buyer computing devices 202. The buyer computing devices 202 can include personal computers, hand-held computers, server computers, personal digital assistants, mobile computing devices, mobile telephones, and any combination thereof. Moreover, although a limited number of buyer computing devices are illustrated, the transaction processing system 200 can include any number of buyer computing devices 202. Additionally, as illustrated in FIG. 2, the transaction processing system 200 can include networks of buyer computing devices 202 that facilitate communication with the transaction processing system. Additionally, one skilled in the relevant art will appreciate that any additional, or different, buyer computing device 202 relationships may be utilized in conjunction with the present invention.

The transaction processing system 200 also includes at least one central processing system 204 in communication with the buyer computing devices 202 via the communication network. The central processing system 204 can communicate with a number of databases for storing and processing seller product data, transaction regulatory information, associated parties information, document transaction data, shipping management data, and other data management information. A more detailed description of the central processing system 204 and any related information storage will be explained in greater detail below.

The transaction processing system 200 includes a number of seller computing devices 206 in communication with the central processing system 204. The seller computing devices 206 can include personal computers, hand-held computers, server computers, personal digital assistants, mobile computing devices, mobile telephones, and any combination thereof. In an illustrative embodiment of the present invention, the seller computing devices 206 maintain and transmit seller product data with the use of a product database 208. Moreover, although a limited number of seller computing devices are illustrated, the transaction processing system 200 can include any number of seller computing devices 206. Similar to the buyer computing devices 202, one skilled in the relevant art will appreciate that a number of seller computing device 206 relationships may be utilized in conjunction with the present invention.

Also in communication with the central processing system 204 are one or more third-party facilitators that may be utilized by a buyer and/or seller to complete a transaction. As illustrated in FIG. 2, the transaction processing system 200 can include one or more shipping computing devices 210 for providing shipping services related to a transaction. The shipping computing devices 210 may be in direct communication with the central processing system 204 and may not be able to communicate directly with the buyer computing devices 202 and/or the seller computing devices 206. Further, the transaction processing system 200 can include additional third-party service providers, such as carriers, financiers, and government officials.

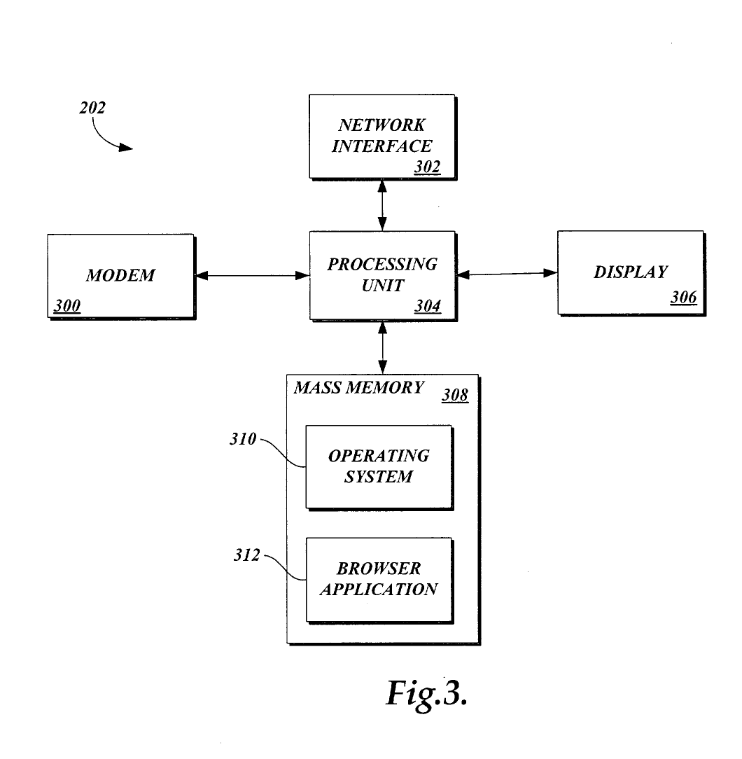

FIG. 3 depicts several of the key components of the buyer computing device 202 (FIG. 2). Those of ordinary skill in the art will appreciate that the buyer computing device 202 includes many more components than those shown in FIG. 3. However, it is not necessary that all of these generally conventional components be shown in order to disclose an illustrative embodiment for practicing the present invention.

As shown in FIG. 3, the buyer computing device 202 may include a modem 300 for connecting to an Internet service provider through a Point-to-Point Protocol (“PPP”) connection or a Serial Line Internet Protocol (“SLIP”) connection as known to those skilled in the art. The modem 300 may utilize a telephone link, cable link, wireless link, Digital Subscriber Line or other types of communication links known in the art. The buyer computing device 202 may also include a network interface 302 for connecting directly to a LAN or a WAN, or for connecting remotely to a LAN or WAN. Those of ordinary skill in the art will appreciate that the network interface 302 includes the necessary circuitry for such a connection, and is also constructed for use with various communication protocols, such as the TCP/IP protocol, the Internet Inter-ORB Protocol (“IIOP”), and the like. The network interface 302 may utilize the communication protocol of the particular network configuration of the LAN or WAN it is connecting to, and a particular type of coupling medium.

The buyer computing device 202 also includes a processing unit 304, a display 306, and a memory 308. The memory 308 generally comprises a random access memory (“RAM”), a read-only memory (“ROM”), and a permanent mass storage device, such as a hard disk drive, tape driver, optical drive, floppy disk drive, CD-ROM, DVD-ROM, or removable storage drive. The memory 308 stores an operating system 310 for controlling the operation of the buyer computing device 202. The memory 308 also includes a WWW browser 312, such as Netscape's NAVIGATOR® or Microsoft's INTERNET EXPLORER® browsers, for accessing the transaction processing system via the WWW. It will be appreciated that these components may be stored on a computer-readable medium and loaded into memory 308 of the buyer computing device 202 using a drive mechanism associated with the computer-readable medium, such as a floppy, CD-ROM, DVD-ROM drive, or network interface 302. The memory 308, display 306, modem 300 and network interface 302 are all connected to the processor 304 via a bus. Other peripherals may also be connected to the processor in a similar manner.

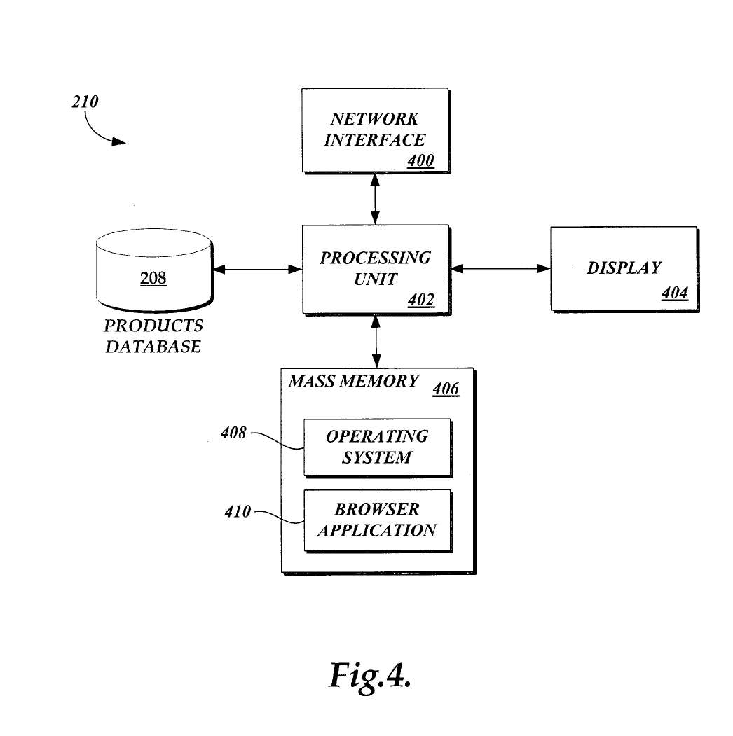

FIG. 4 depicts several of the key components of the seller computing device 206(FIG. 2). Those of ordinary skill in the art will appreciate that the seller computing device 206 includes many more components than those shown in FIG. 4. However, it is not necessary that all of these generally conventional components be shown in order to disclose an illustrative embodiment for practicing the present invention.

As shown in FIG. 4, the seller computing device 206 may include a network interface 400 for connecting directly to a LAN or a WAN, or for connecting remotely to a LAN or WAN. Those of ordinary skill in the art will appreciate that the network interface 400 includes the necessary circuitry for such a connection, and is also constructed for use with various communication protocols, such as the TCP/IP protocol, IIOP, and the like. The network interface 400 may utilize the communication protocol of the particular network configuration of the LAN or WAN it is connecting to, and a particular type of coupling medium. As also illustrated in FIG. 2, the seller computing device 206 may utilize a products database 208 to manage product data.

The seller computing device 206 also includes a processing unit 402, a display 404, and a memory 406. The memory 406 generally comprises a random access memory (“RAM”), a read-only memory (“ROM”), and a permanent mass storage device, such as a hard disk drive, tape driver, optical drive, floppy disk drive, CD-ROM, DVD-ROM, or removable storage drive. The memory 406 stores an operating system 408 for controlling the operation of the seller computing device 206. The memory 406 also includes a WWW browser 410, such as Netscape's NAVIGATOR® or Microsoft's INTERNET EXPLORER® browsers, for accessing the transaction processing system via the WWW. It will be appreciated that these components may be stored on a computer-readable medium and loaded into memory 406 of the seller computing device 206 using a drive mechanism associated with the computer-readable medium, such as a floppy, CD-ROM, DVD-ROM drive, or network interface 400. The memory 406, display 404, and network interface 400 are all connected to the processor 402 via a bus. Other peripherals may also be connected to the processor in a similar manner.

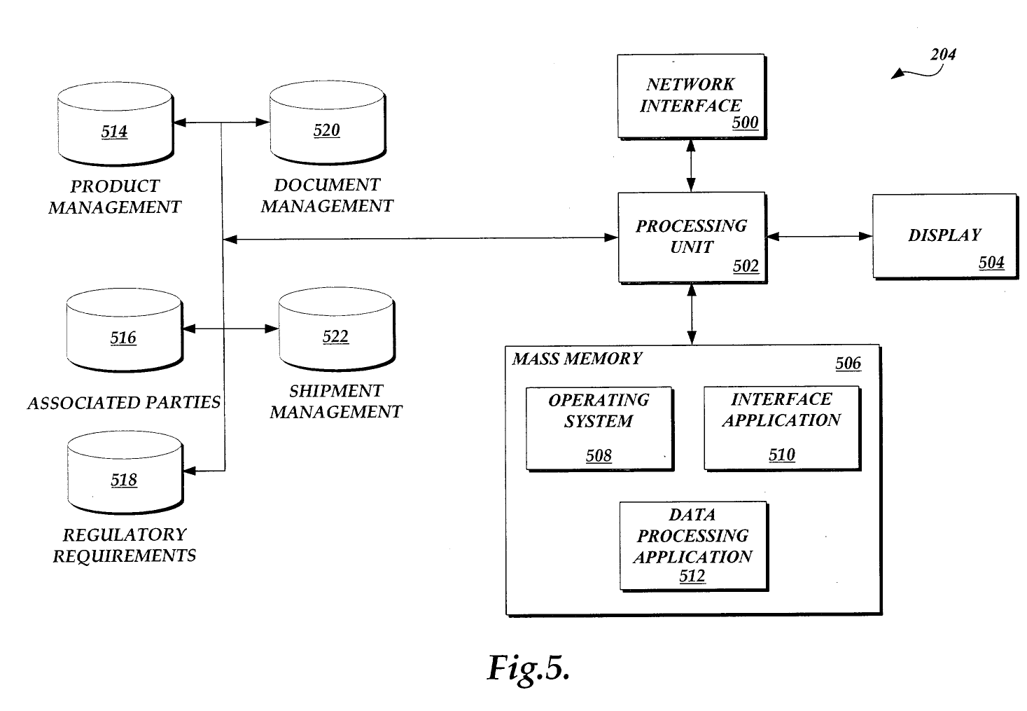

FIG. 5 is a block diagram depicting an illustrative architecture of a central processing system 204 (FIG. 2) in accordance with the present invention. Those of ordinary skill in the art will appreciate that the central processing system 204 includes many more components than those shown in FIG. 5. However, it is not necessary that all of these generally conventional components be shown in order to disclose an illustrative embodiment for practicing the present invention. As shown in FIG. 5, the central processing system 204 is connected to the Internet 20 via a network interface 500. Those of ordinary skill in the art will appreciate that the network interface 500 includes the necessary circuitry for connecting the central processing system 204 to the Internet 20, and is constructed for use with the TCP/IP protocol, or other protocols, such as IIOP.

The central processing system 204 also includes a processing unit 502, a display 504 and a mass memory 506, all connected via a communication bus, or other communication device. The mass memory 506 generally comprises a RAM, ROM, and a permanent mass storage device, such as a hard disk drive, tape drive, optical drive, floppy disk drive, or combination thereof. The mass memory 506 stores an operating system 508 for controlling the operation of the central processing system 204. It will be appreciated that this component may comprise a general-purpose server operating system as is known to those skilled in the art, such as UNIX, LINUX™, or Microsoft WINDOWS NT®. As described above, the central processing system 204 can utilize a variety of information sources for providing functionality to the components of the transaction processing system 200. In an illustrative embodiment of the present invention, the central processing system 204 can include a product management database 514 for managing product information, an associated parties database 516 for correlating additional parties to a transaction, a regulatory requirements database 518 for correlating governmental or other regulatory information for transactions, a document management database for generating transaction documents, and a shipment management database for correlating shipping transaction data. One skilled in the art will appreciate, that additional or alternative data sources may also be utilized in accordance with the present invention.

The mass memory 506 also stores program code and data for interfacing with one or more buyers, one or more sellers, additional third-parties, and for processing international transaction data. More specifically, the mass memory 506 stores a component interface application 510 in accordance with the present invention for communicating with buyer computing devices 202, seller computing devices 206 and shipper computing devices 210. The component interface application 510 comprises computer-executable instructions which, when executed by the central processing system 204, interfaces with the various components of the transaction processing system 200 as will be explained below in greater detail. The mass memory 506 further stores a data processing 512 for associating buyer and seller data in accordance with the transaction processing aspect of the present invention. The data processing application 512 may also be utilized to associate buyers and sellers with a shipping computing device 210 in accordance with another aspect of the transaction processing system 200. The operation of the data processing application 512 will be described in greater detail below. It will be appreciated that these components may be stored on a computer-readable medium and loaded into the memory 506 of the central processing system 204 using a drive mechanism associated with the computer-readable medium, such as a floppy, CD-ROM, DVD-ROM drive, or network interface 500.

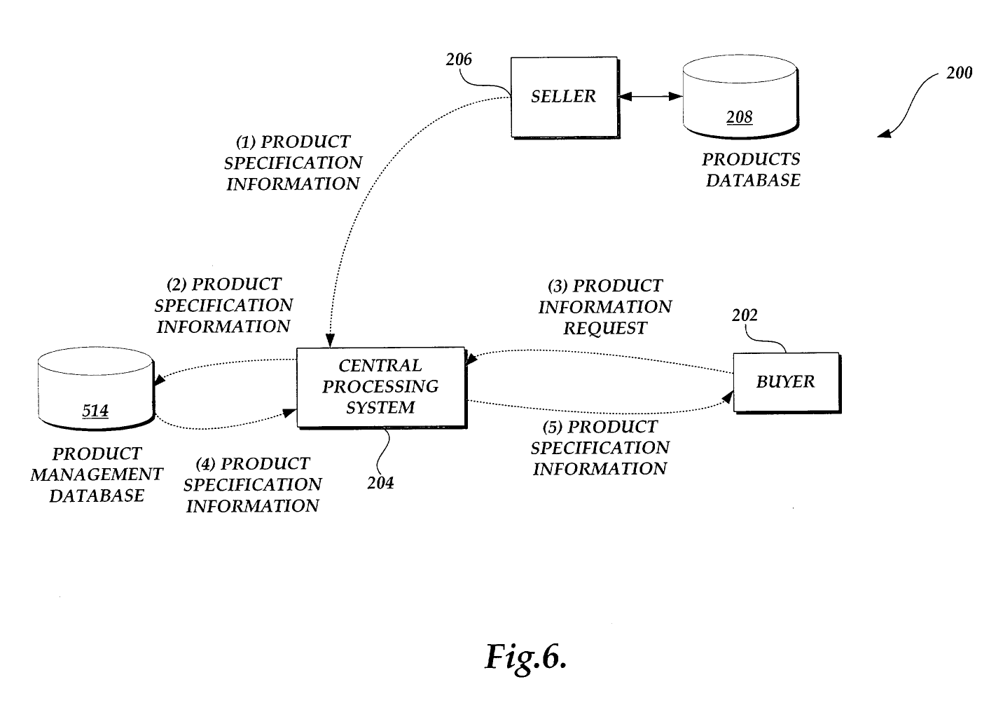

Referring now to FIGS. 6-18, a number of embodiments implementing various aspects of the present invention will be described. One skilled in the relevant art will appreciate the block diagram illustrating various interactions between the components of the transaction processing system 200 and/or the screen interfaces provided to the components are illustrative in nature and should not be construed as limiting. Further, one skilled in the relevant art will appreciate that alternative or additional components/features may also be incorporated in accordance with the present invention.

FIG. 6 is a block diagram of the transaction processing system 200 illustrating the management and transmission of seller product data by the central processing system 204 in accordance with the present invention. One or more seller computing devices 206 provide the central processing system 204 with data relating to an identification of the products that are available for a transaction and additional attributes of the products that may be required to complete a sales transaction. The data provided by the seller computing devices 204 is stored in the product management database 514 and is generally referred to as product data. As will be explained in greater detail below, the product data may include seller specified data, such as internal descriptions, codes, and industry specified data, such as tariff codes, identification information, processing information and the like. Further, the product data can include additional attribute data, such as video data, including still pictures and actual video data, and audio data.

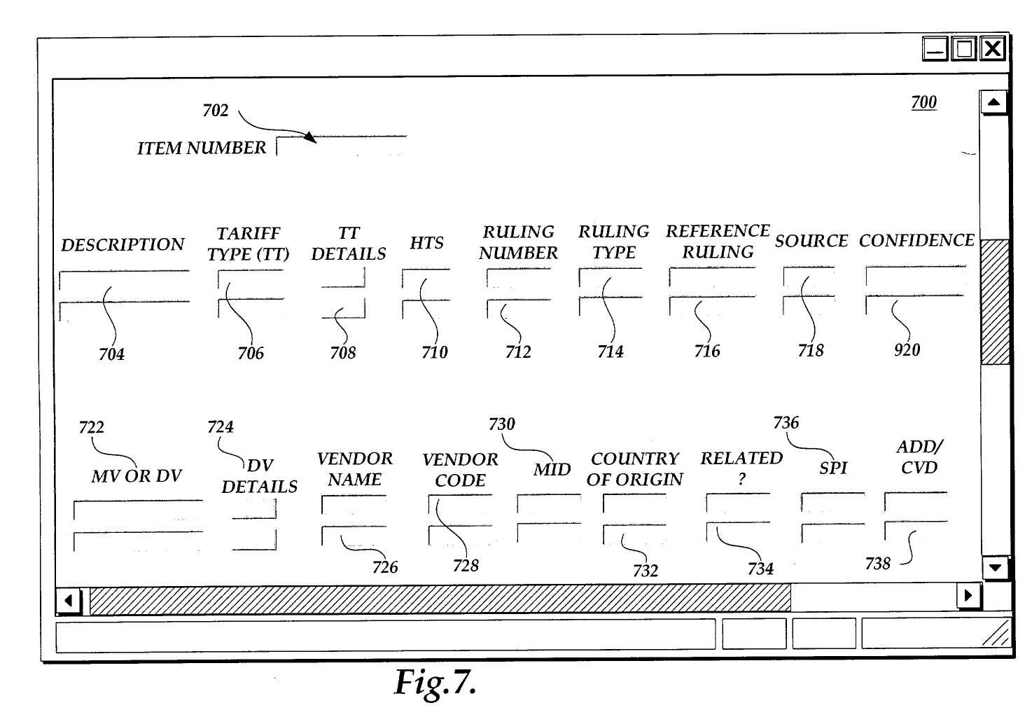

FIG. 7 is a block diagram of a screen display 700 generated by a seller computing device 206 to transmit and manage product data to the central processing system 204. In accordance with the present invention, the seller computing device 206 may generate the screen display 700 to allow a user to complete one or more fields of the data for each piece of product offered by the seller. Alternatively, the seller computing device 206 may utilize some type of integration process to allow at least a portion of the product data to be integrated from previous entries in the product database 208. Still further, in an illustrative embodiment of the present invention, the screen display 700 can utilize a variety of business rules that restrict the type of entries that are allowed to filled to facilitate the completion process. The screen display 700 will be utilized to illustrate the type of data that may be required to offer a product for sale. However, one skilled in the relevant art will appreciate that additional or alternative data fields may be included and that alternative user interfaces may be practiced in accordance with the present invention.

As illustrated in FIG. 7, the screen display 700 includes a first field 702 for specifying a particular item number for a piece of inventor a field 704 for specifying a description of the item. The screen display 700 also includes a field 706 for designating a tariff type 706 and an additional interface 708 for obtaining tariff type details screen. In an illustrative embodiment of the present invention, the tariff type field may be selected from values corresponding to primary, compound and set.

The screen display 700 also includes a Harmonized Tariff Schedule (“HTS”) field 710 for designating an appropriate HTS reference number. In an illustrative embodiment of the present invention, the screen display 700 can utilize additional entry completion functionality for completing fields, such as the HTS field 710. In accordance with this embodiment, the classification of an appropriate HTS classification can be processed as a choice selection in which there is only a single value that is appropriate. Accordingly, the central processing system 204 can validate the selected classification. Alternatively, an appropriate HTS classification can be processed as a set in which multiple values may be appropriate depending on an attribute of the product. Accordingly, the screen interface 700 may allow for multiple values to be entered for a product attribute. The screen display also includes fields for designating ruling classifications for a particular items that include a ruling number field 712, a ruling type field 714 and a reference ruling field 716. The screen display 700 further includes a source field 718 and a confidence field 720. One skilled in the relevant art will appreciate that some fields may be dependent on the values of other fields. For example, if a tariff type is designated as “SET”, the reference number, ruling type and reference ruling fields 712, 714, and 716 will be blocked out and cannot be set. The screen display 700 can also include one or more notes fields (not shown) that may be utilized to identify the source of the data and/or to explain particular data values.

With continued reference to FIG. 7, the screen display 700 can also include one or more fields corresponding to the particular vendor providing the product item. More specifically, the screen display 700 can include a vendor designation field 722 for specifying whether the providing vendor is a manufacturing vendor or a distributing vendor. The screen display 700 also includes a control field 724 for specifying information regarding a distributing vendor. The screen display 700 can also include a vendor name field 926, vendor code field 728, MID field 730 and country of origin field 732. The screen display 700 can further include a related product field 734, SPI field 736 and ADD/CVD field 738.

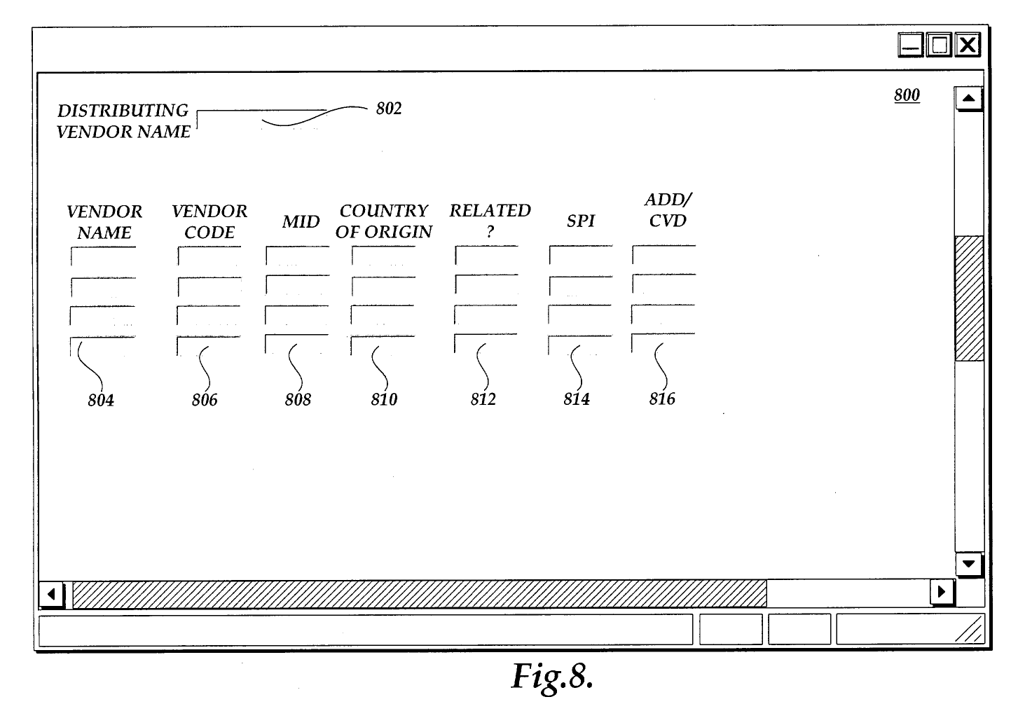

With reference now to FIG. 8, the control field 724 (FIG. 7) allows the seller to provide additional information relating to third-parties associated with a transaction. For example, FIG. 8 illustrates a screen display 800 for associating distributing vendor information for seller products having multiple sources. Similar to screen display 700, the distributing vendor screen display 800 includes a number of fields corresponding to the distributing vendor. More specifically, the screen display 800 includes a vendor identification field 802, a vendor name field 804, a vendor code field 806, a MID field 808, a country of origin field 810, a related product field 812, a SPI field 814 and an ADD/CVD field 816. The central processing system 204 may also utilize graphical interfaces (not shown) to allow a user to establish various relationships with other third-party providers.

Returning to FIG. 6, the central processing system 204 obtains the product data from the seller computing device 206 and stores the product information in the product management database 514. In an illustrative embodiment of the present invention, each product item is maintained according to a number of attributes that correspond to the attribute. Accordingly, the product entries may be searched according to attribute to identify any products matching search criteria. The search queries may be entered by any authorized component of the transaction processing system 200. However, the results of the search may be limited to a particular subset of product data the searcher is authorized to view. In one aspect, each user may be presented with a set of pre-defined searches provided by the central processing server 204. For example, the central processing server 204 may provide a set of pre-defined search queries depending on the typical actions of the user or the organization the user is associated with. In another aspects, one or more of the product queries may be saved by the searcher and reused again. For example, a combination of pre-defined and saved searches may be utilized to generate work queues for identifying products in the products database 214 or in the seller computing devices products database 208 (FIG. 2).

In another illustrative embodiment of the present invention mass actions, such as data updates or data modifications, may be applied to a listing of product items found in a search. In accordance with this embodiment, an authorized user may utilize the work queues, pre-defined queries, saved queries or new queries to identify any product items meeting the search criteria. The authorized user can then specify the modification of an attribute and the addition of an attribute for at least a portion of the items returned in the query. Accordingly, the authorized user may be given a listing of all product items eligible for modification and allow the user to select which, if any, should be modified. Alternatively, the mass update feature may require that all listed product items be updated.

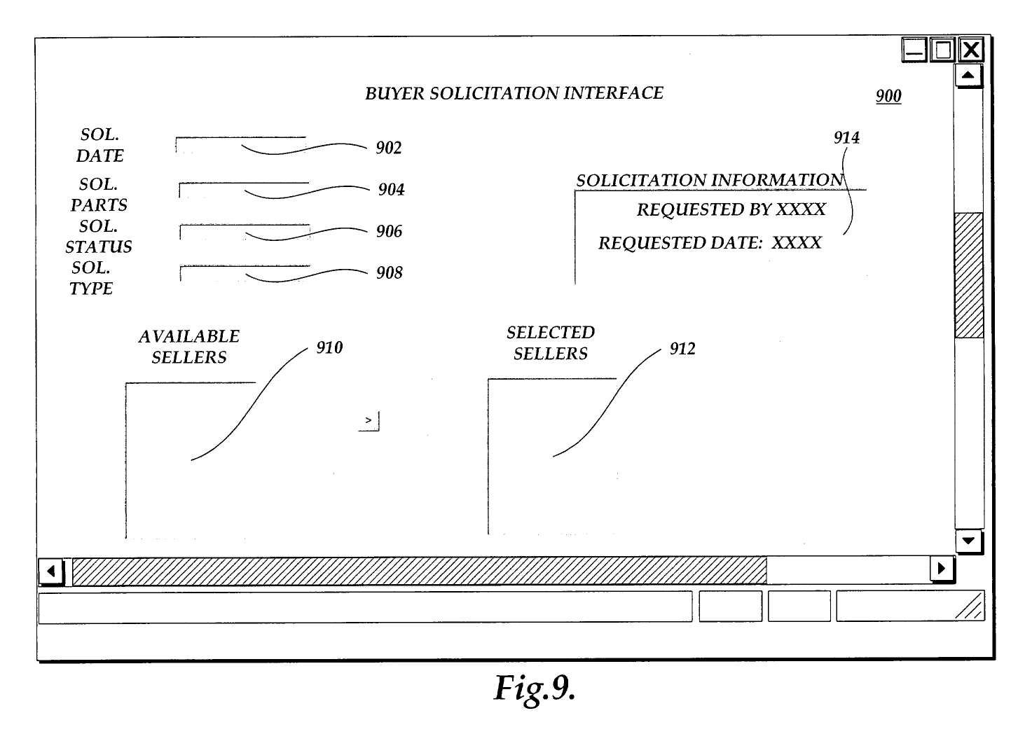

FIG. 9 is a block diagram illustrative of a screen display 900 generated by a buyer computing device 202 to generate a buyer solicitation. Although the user interface 900 will be described in terms of a buyer computing device 202, other computing devices may utilize the user interface 900 to initiate a solicitation of the product items stored in the product database. As illustrated in FIG. 9, the screen display 900 includes a field 902 for entering solicitation date, a field 904 for entering the types of part solicited for, a field 906 for entering a solicitation status, a field 908 for entering a solicitation type. The screen display 900 can also include fields 910 and 912 for specifying product items provided by specific sellers. Further, the screen display 900 can include a solicitation information 914 that designates the origin of the solicitation and that can be utilized by a seller computing device 206. One skilled in the relevant art will appreciate that alternative screen interfaces may also be utilized in accordance with the present invention.

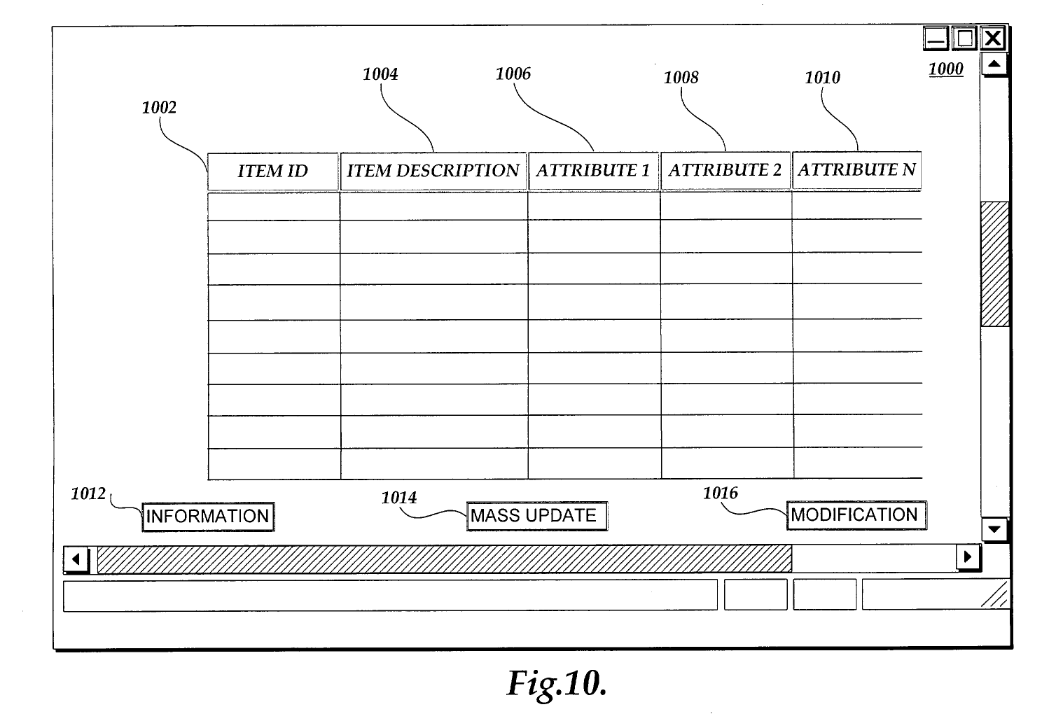

FIG. 10 is a block diagram of a screen display 1000 generated by a computing device illustrative of a listing of product items maintained in the products database 514 and satisfying criteria submitted by a user. As described above, each product item may be associated with a number of attributes that may be searched. Accordingly, the listing of the product can include an identification of various product attributes. As illustrated in FIG. 10, a common type of product item may be associated with an product item ID 1302, an product item description 1004 and a number of product item attributes 1006, 1008 and 1010. In an actual embodiment of the present invention, product items may be associated with a digital image file, corresponding to an image of the product item. Accordingly, the screen display 1000 can designate a column, such as column 1010, for managing product image information. The image information may be directly accessed by manipulating a control or transmitted to a requesting computing device. The screen display 1000 can also provide additional functionality, such as additional controls, that allows for the manipulation of the product data. For example, the screen display 1000 can include an information control 1012 for obtaining additional information regarding a selected product item. The screen display 1000 can also have a mass updated control 1014 for implemented a mass update on selected product items. The screen display 1000 can further include a modification control 1016 for modifying the attributes of a selected product item.

Returning again to FIG. 6, after the product information is stored by the central processing system 204, a computing device, such as the buyer computing device 202, may transmit a request for product information. The request for information may correspond to a solicitation for available seller product. Based upon the search criteria submitted by the buyer computing device 202, the data processing application 512 of the central processing system 204 transmits the relevant product specification information to the buyer computing device 202. Although a buyer computing device 202 is shown as transmitting the solicitation request, one skilled in the relevant art will appreciate that the solicitation request may be generated from seller computing devices 206, shipping computing devices 210 and the like.

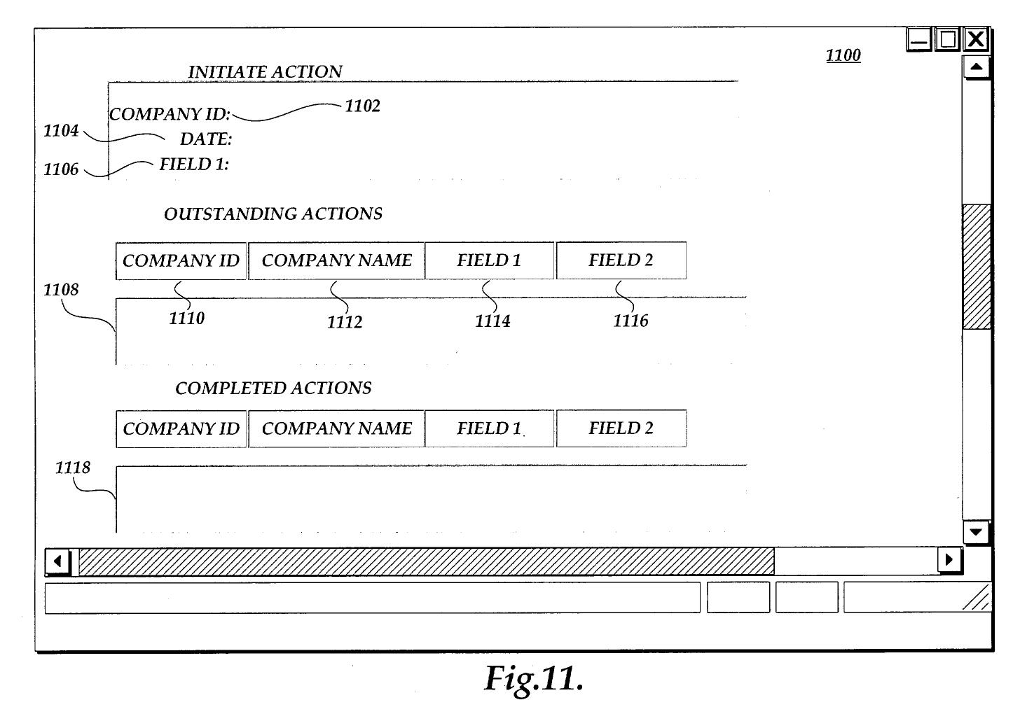

With reference now to FIG. 11, the central processing system 204 may provide a user interface 1100 to initiate action items or manage existing action items on the product item data stored in the product management database 514. In an illustrative embodiment of the present invention, the user interface 1100 may be utilized to implement various business work queues established by a user. As explained above, the work queues allow a user to search for product item data utilizing a combination of pre-defined and saved queries. As illustrated in FIG. 11, the illustrative user interface 1100 includes a portion for defining the new action item. The portion can include a field 1102 for specifying a company name, a field 1104 for specifying a date, and a number of fields 1106 for specifying one or attributes of the companies product. In an illustrative embodiment of the present invention, the user does not have to enter all of the fields, but only the fields that are of interest in matching. Additionally, the user interface 1100 may be specifically configured to a specific action. For example, the user interface 1100 may only allow users to initiate a mass update. Accordingly, the central processing system 204 may generate a number of iterations of the user interface 1100 to implement any number of actions.

The screen interface 1100 also includes a portion 1108 for displaying any outstanding action items being implemented. The portion 1108 includes a detailed listing of all the product item data effected by the action item. More specifically, in an illustrative embodiment of the present invention, the portion 1108 includes columns 1110, 1112, 1114, and 1116 for identifying the relevant fields of the product item data effected by the pending action item. In a similar manner, the screen interface 1100 also includes a portion 1118 that includes a detailed listing of all the product item data that has been affected by a completed action item. Similar to portion 1108, portion 1118 also includes columns for identifying the relevant fields of the product item data effected by the completed action item.

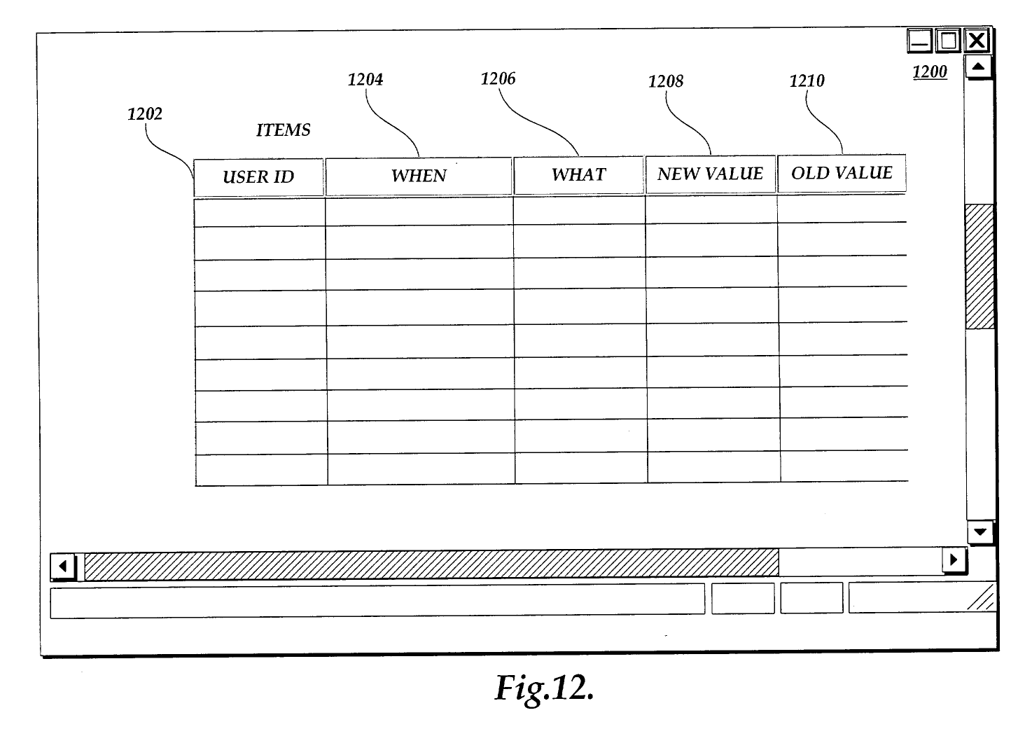

With reference now to FIG. 12, in accordance with another embodiment of the present invention, the central processing system 204 may also generate a user interface 1200 for tracking the modification of product item data in the product management database 514. As described above, the product item data may be modified individually by an authorized user or as part of a mass update. As illustrated in FIG. 12, the user interface 1200 includes a column 1202 for identifying the particular user that modified the action item data. The user interface 1200 also can include columns 1204 and 1206 for indicating when the data was modified and what particular field values where modified. Additionally, the user interface 1200 can include columns 1208 and 1206 for indicating what the old value and new value of the field. By providing the user interface 1200, the product item integrity can be monitored. However, one skilled in the relevant art will appreciate that additional or alternative columns may be utilized in conjunction with the present invention.

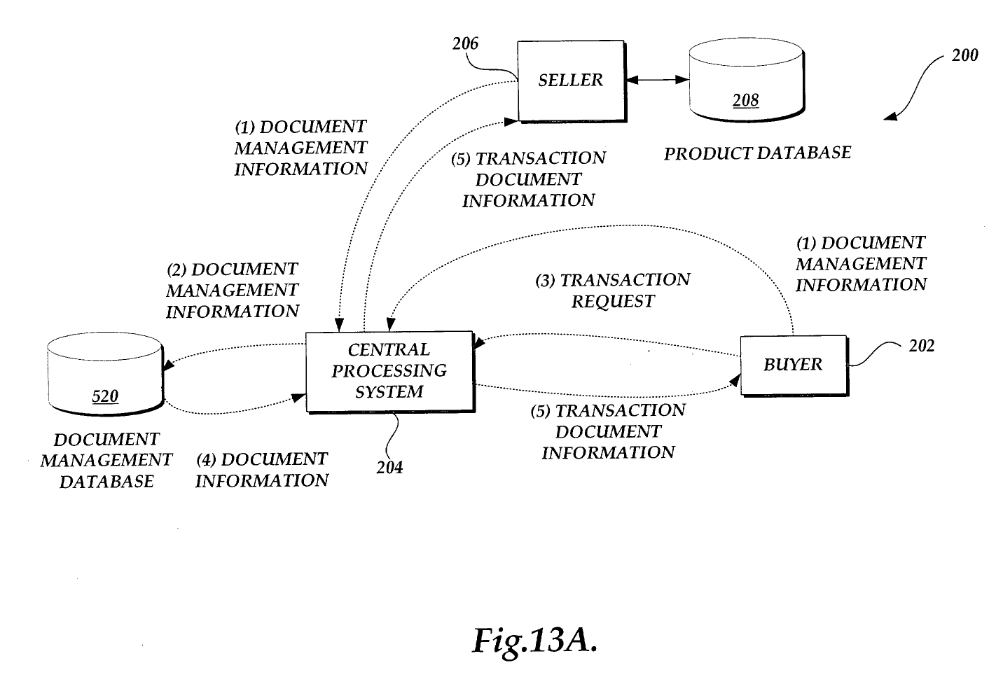

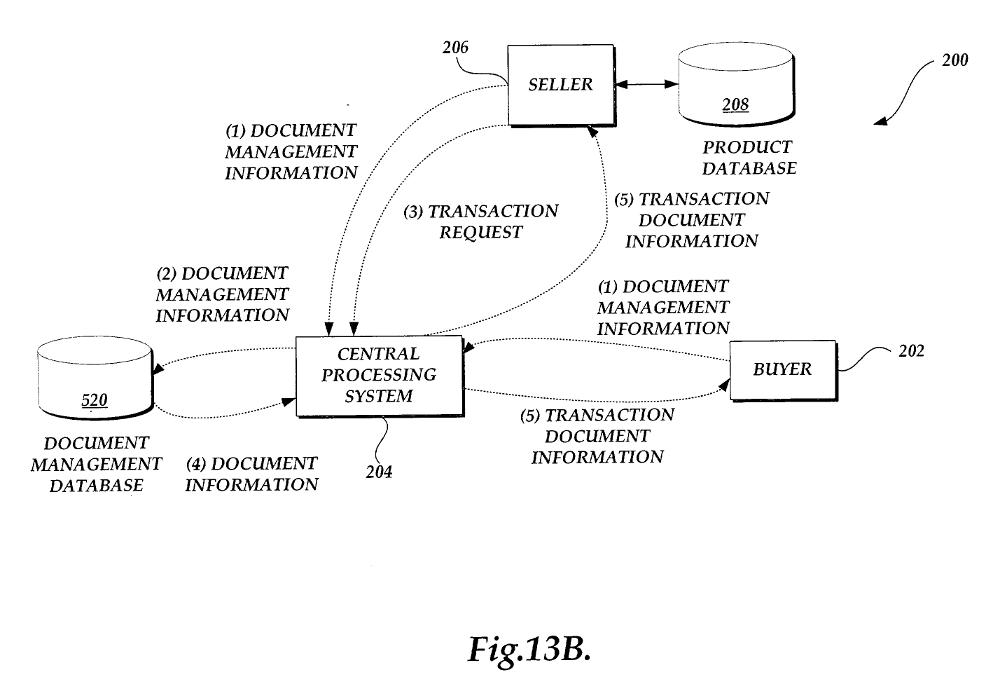

Turning now to FIGS. 13A and 13B, in another aspect of the present invention, once a buyer computing device 202 and seller computing device 206 wish to complete a transaction, the transaction processing system 200 can facilitate the transaction by the generation and transmission of any required documentation. In an illustrative embodiment of the present invention, the transaction processing system may be utilized to facilitate international transaction requiring a number of documents. However, the transaction processing system 200 may be utilized to facilitate domestic transactions as well.

With reference to FIG. 13A, the buyer computing device 202 and the seller computing device 202 submit to the central processing system 204 document management information. In an illustrative embodiment of the present invention, the document management information can include information typically utilized to complete a transaction, such as general contact information. Additionally, the document management information can include an identification of one or more designated signatories for each respective entity associated with the buyer/seller. The document management information can further include facsimile signature data of the designated signatories that can be affixed to documentation in the event a transaction occurs. In accordance with an actual embodiment of the present invention, the buyer and seller computing devices can transmit the document management information during an enrollment procedure or as part of a transaction.

At some point, a buyer computing device 202 may transmit a transmission request to the central processing system 204. Based on the transmission request, the data processing application 512 of the central processing system 204 identifies one or more documents that may be necessary to complete the requested transaction. The central processing system 204 obtains the documents from the document management database 520. In an illustrative embodiment of the present invention, the data processing application 512 obtains document templates from the document management database 520 and merges the document templates with information specific to the designated buyer and seller computing devices. For example, the data processing application 512 can merge the facsimile copy of a required signatory into the document. Once the documents have been generated/merged, the central processing system 204 transmits the required documentation to buyer computing device 202 and/or the seller computing device 206.

With reference to FIG. 13B, in another illustrative embodiment of the present invention, the transmission request may be generated by another component of the transaction processing system 200, such as the seller computing device 206. As described above, the data processing application 512 of the central processing system 204 identifies one or more documents that may be necessary to complete the requested transaction. The central processing system 204 obtains the documents from the document management database 520. In an illustrative embodiment of the present invention, the data processing application 512 obtains document templates from the document management database 520 and merges the document templates with information specific to the designated buyer and seller computing devices. For example, the data processing application 512 can merge the facsimile copy of a required signatory into the document. Once the documents have been generated/merged, the central processing system 204 transmits the required documentation to buyer computing device 202 and/or the seller computing device 206.

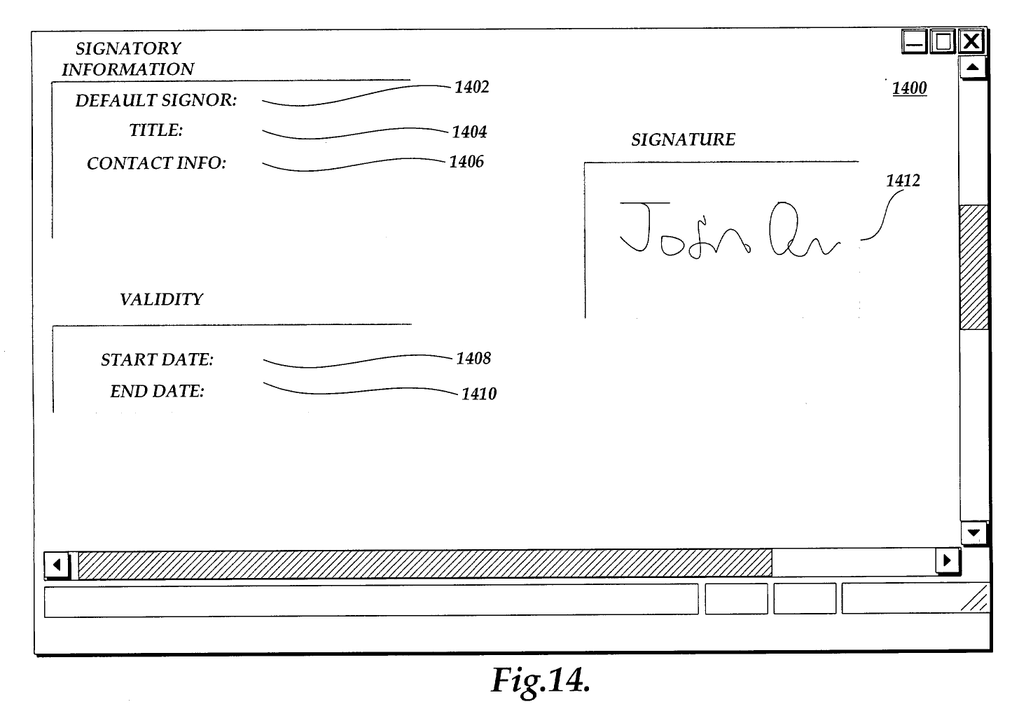

With reference now to FIG. 14, the central processing system 204 may utilize a user interface 1400 for obtaining signatory document management information. The user interface 1400 includes a portion for obtaining signatory information, such as the name of the default signor 1402, the title of the signor 1404, and the signor's contact information 1406. The user interface 1400 also includes a portion for specifying the validity of the signor such as start date 1408 and an end date 1410. The user interface 1400 also can include a signature portion 1412 that includes the facsimile portion of the designated signatory. In an illustrative embodiment of the present invention, the user interface 1400 may be utilized to designate any number signatories for a particular entity. Further, the user interface 1400 may include additional fields for specifying one or more conditions that must be satisfied to allow the default person to sign on behalf of the entity.

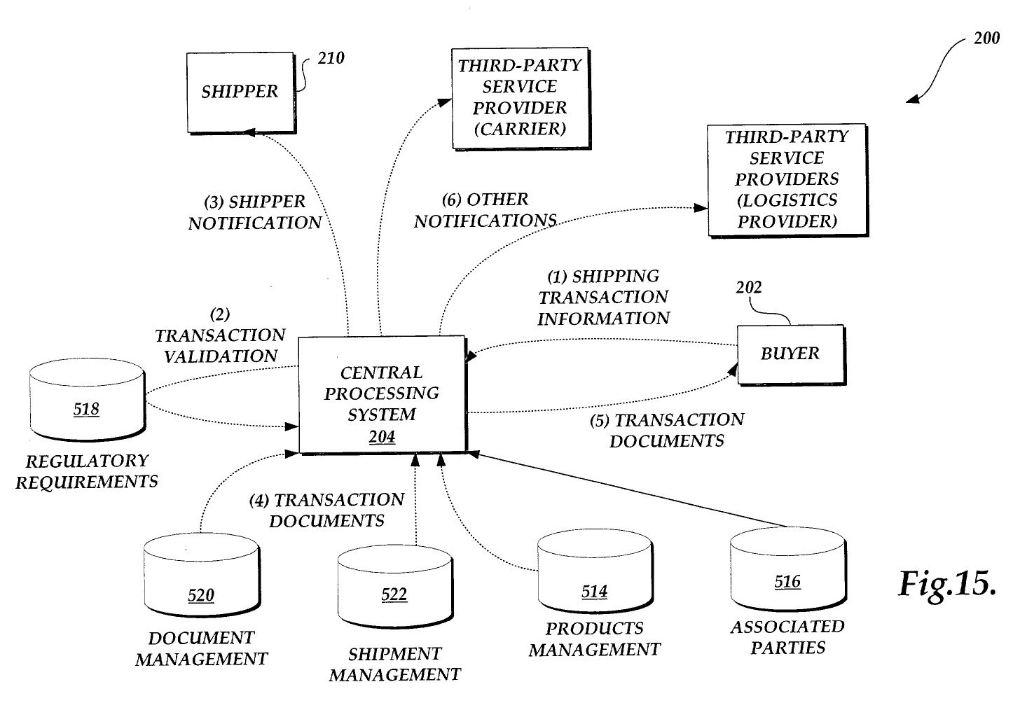

Turning now to FIG. 15, in another aspect of the present invention, upon the completion of a transaction, an entity, such as the buyer computing device 202 may utilize the transaction processing system 200 to manage a shipping aspect of the transaction. As illustrated in FIG. 15, the buyer computing device 202 transmits shipping transaction request to the central processing system 204. The shipping transaction request can include a designation of a shipping entity, represented by a shipping computing device 210, and any additional shipping information required for the transaction. However, one skilled in the relevant art will appreciate that other components of the transaction processing system 200 may submit transaction information.

The central processing system 204 obtains the shipping transaction information and validates the shipping information. In an illustrative embodiment of the present invention, the data processing application 512 of the central processing system 204 may verify that the shipping designation is not prevented by governmental laws, regulations or by internal regulations of the shipping company or transaction processing company. Further, the data processing application 512 may verify that the designated recipient is not prevented from receiving the designated goods by the governmental laws, regulations or by internal regulations. One skilled in the relevant art will appreciate that the data processing application 512 may also verify additional information as well. To complete this processing, the central processing system 204 may obtain pre-defined regulatory information from the regulatory requirements database 518.

If the transaction can be validated, the data processing application 512 obtains one or more shipping documents from the document management database 520 and generates any required documents. In an illustrative embodiment of the present invention, the data processing application can obtain document templates from the document management database 520 and merge buyer, seller and shipper specific information to generate the appropriate documents. The central processing server 204 can also obtain information about the designated parties such as the buyer, seller, shipper, carrier, etc. from the shipment management database 522, product attribute information for selected product items from the products management database 514, and additional associated party information from the associated party database 516 and merge the additional information into the document templates.

Once the shipping documents have been generated, the central processing system 204 transmits a notification to the shipping computing device 210. In an illustrative embodiment of the present invention, the notification can include electronic mail, data files, XML data streams as specified by the shipping computing device 210. Additionally, the central processing system 204 transmits the shipping documents to the buyer computing device 202, seller computing device 206 and/or the shipping computing device 206. Additional notifications may also be issued to third-party providers such as carriers, logistic providers, financiers, etc. in a manner specified for the transaction. In an alternative embodiment of the present invention, the central processing system 204 may also serve as a designated shipping computing device 210, and would internally process all communication designated for the shipping computing device.

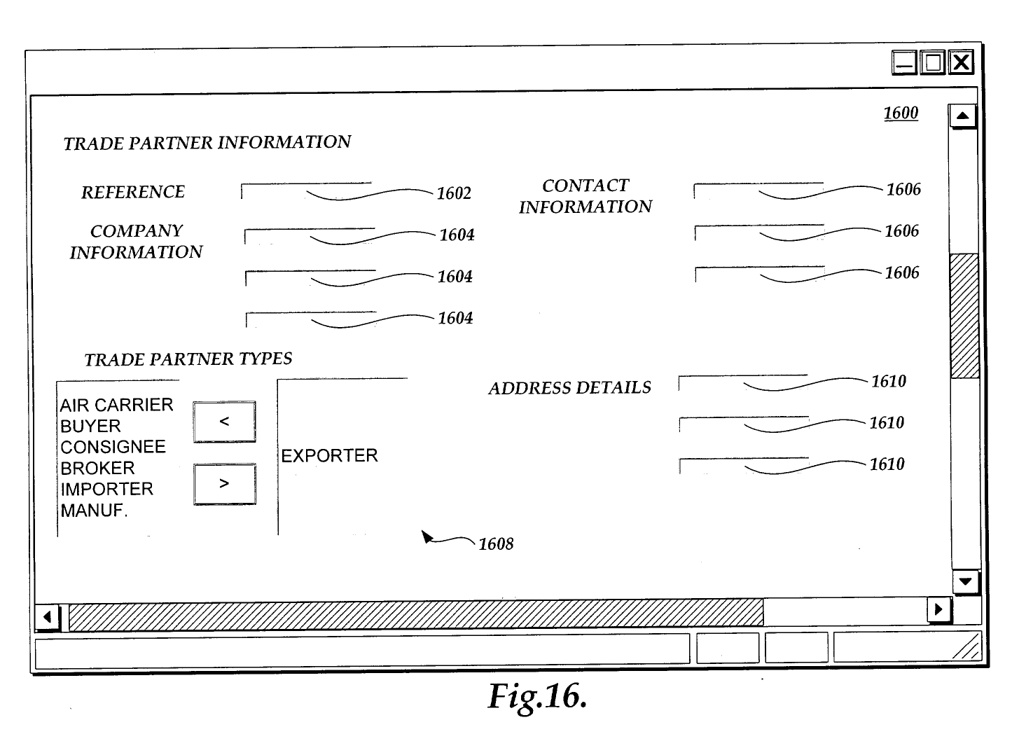

FIG. 16 is a block diagram illustrative of a screen display 1600 generated by computing device to obtain associated party information in accordance with the present invention. In an illustrative embodiment of the present invention, the associated party is a trade partner utilized to complete one or more aspects of a transaction. However, one skilled in the relevant art will appreciate that the screen display 1600 may be utilized to associated parties not necessarily considered a trade partner.

The screen display 1600 includes a reference field 1602 for generating a reference for a particular associated party. A reference may be entered directly into the reference field 1602 through a user input device, such as a keyboard. Alternatively, a reference may selected from a pre-set number of selections. As will be describe below, the reference for a trade partner may be used to complete portions of other screen displays requiring the selection of an entity. The screen display 1600 can also include a company identification portion 1604 utilized to identify more detailed aspects of a particular trade partner. In an illustrative embodiment of the present invention, the company identification portion 1604 can include a number of fields for completing detailed address information and other identification information, such as tax identifiers, etc. The screen display 1600 can also include a contact information portion 1606 utilized to identify communication preferences for the identified trade partner. In an illustrative embodiment of the present invention, the contact information portion 1606 can include a number of fields for specifying contact personnel, telephone numbers, email addresses, facsimile numbers, and other communication information.

The screen display 1600 can also include a trade partner type portion 1608 utilized to characterize the role or roles that the trade partner will perform for another component of the system 200. In an illustrative embodiment of the present invention, the role that each trade partner is characterized may be utilized to complete transactions by including/excluding trade partners. For example, the central processing system 204 may provide a pre-determined list of all exporter trade partners that allows a buyer to select an exporter. Accordingly, the trade partner would have to be designated as an “exporter” to be included in the list. In another embodiment of the present invention, the classifications may also be utilized to determine an authorization level to transaction information. For example, a trade partner designated as an air carrier may have more limited access to information than a trade partner characterized as a customs broker. As illustrated in FIG. 16, the screen display 1600 can include a listing of acceptable trade partner types in which a user can select one or more trade partner types. The screen interface 1600 can also include an additional address details portion 1610 that may be utilized to enter additional contact addresses or other trade partner information.

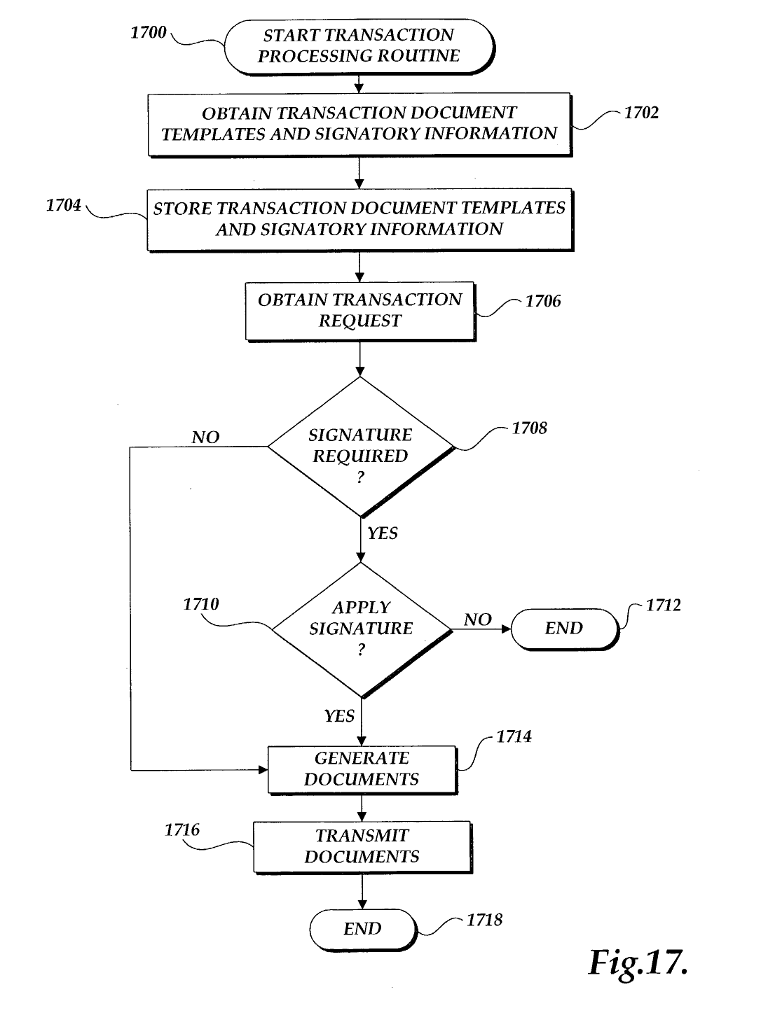

With reference now to FIG. 17, a routine 1700 implemented by the central processing system 204 for processing a transaction request requiring transaction documentation will be described. At block 1702, the central processing system 204 obtains transaction document templates and signatory information. In an illustrative embodiment of the present invention, the transaction document templates and/or the signatory information may be obtained from a number of sources. For example, the transaction document templates may be obtained from a source, such as a government agency, that requires specific a specific document format to facilitate transaction. Additionally, some of the document templates may be internally generated or generated by the parties to receive the completed documents. Additionally, the signatory information can be obtained from the individual parties communicating with the transaction processing system 200. Each individual party can submit the signatory information prior to a transaction, such as during a registration period, or upon the initiation of a transaction request. Additionally, one skilled in the relevant art will appreciate that the transaction document templates and signatory information may be updated at any time during the transaction processing routine. At block 1704, the central processing system 204 stores the transaction document templates and signatory information in the document management database 520.

At block 1706, the interface application 510 of the central processing system 204 obtains a transaction request. In an illustrative embodiment of the present invention, a transaction request will generally originate from the buyer computing device 202. At decision block 1708, a test is performed to determine whether a signature is required to complete the transaction. If a signature is not required, the routine 1700 proceeds to block 1714, which will be explained in greater detail below. Alternatively, if a signature is required at decision block 1710, a test is conducted to determine whether the central processing system 204 may apply a signature. As described above, the signatory information can include a default signature for an entity, such as a buyer computing device 202, and one or more criteria for determining what type of transaction the signator may approve. Accordingly, the central processing system 204 can apply the criteria to determine whether a signature is applicable. If the central processing system 204 cannot apply a signature (e.g., the criteria is not satisfied), the routine 1700 terminates at block 1712. Alternatively, if the signature may be applied at block 1714, data processing application 512 of the central processing system 204 generates the documents required for the transaction. In an illustrative embodiment of the present invention, the generation of documents can include obtaining the transaction document templates from the document management database 520 and merging transaction specific information, including contact information, transaction information and facsimile signatory information, to generate the appropriate documents for the particular transaction. At block 1716, the central processing system 204 can transmit the documents to one or more parties requiring the documents for the transaction. At block 1718, the routine 1700 terminates.

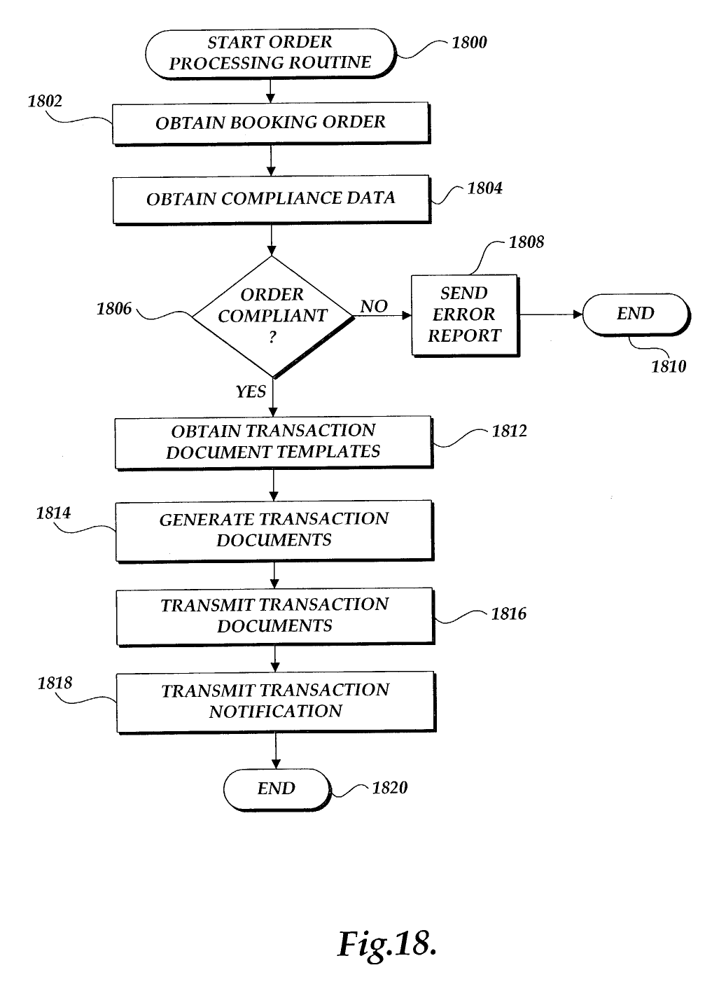

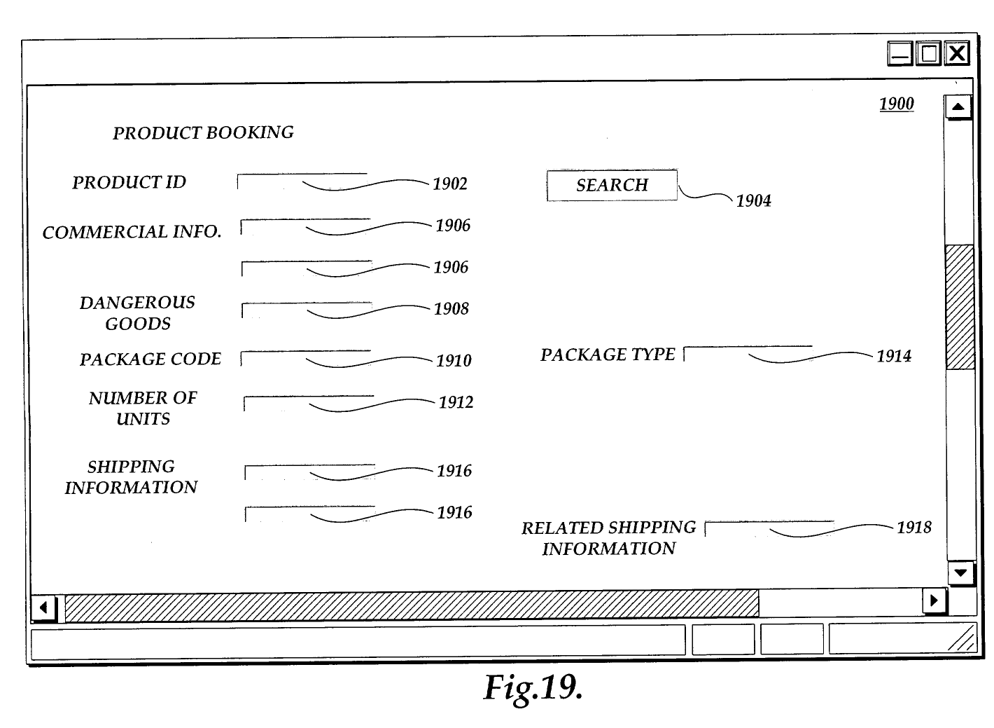

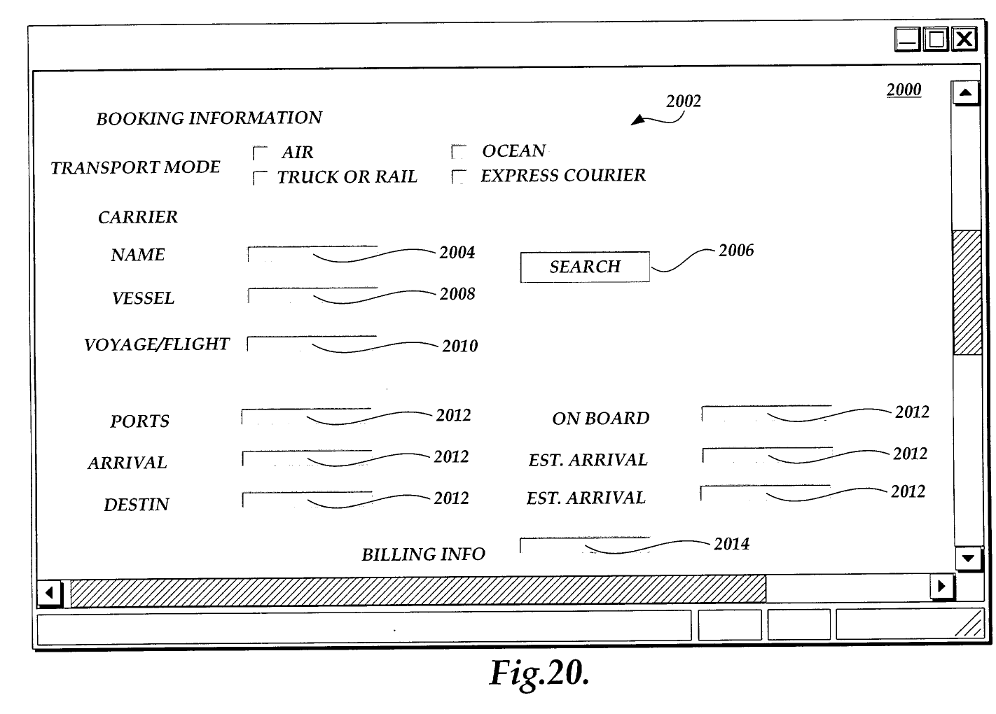

Turning now to FIG. 18, a routine 1800 for processing a shipping order, or booking order, and implemented by the central processing system 204 will be described. At block 1802, the processing server 204 obtains a booking order from a buyer computing device 202. In an illustrative embodiment of the present invention, the booking information can include a specification of the shipping requirements for a given product, a specification of one or more carriers for the shipment and any additional data associated with booking/shipping a particular product. For example, a specific product may require additional shipping/booking information not typically associated with the shipment of other products. The booking information may be entered by a party via a computer interface, as illustrated in FIGS. 19 and 20 below. Additionally, the central processing system 204 may pre-selected some of the data utilize to complete the booking information.

At block 1804, the central processing system 204 obtains compliance data from the document management database 520. In an illustrative embodiment of the present invention, compliance data can include a variety of data to determine whether a transaction is proper. As explained above, the criteria for compliance data can vary greatly depending on the type of transaction, domestic versus international, and the type of products being shipped. For example, the compliance data can include data to ensure that no governmental rules or regulations (e.g., trade embargoes) are violated. Additionally, the compliance data can include data to implement internally generated policies. Still further, the compliance data can include data to implement externally generated policies (e.g., seller's policies). At decision block 1806, a test is conducted to determine whether the order is compliant. If the order is not compliant, the central processing system 204 sends an error report at block 1808 and the routine 1800 terminates at block 1810.

Alternatively, if the order is compliant, at block 1812, the central processing system 204 obtains additional document templates from the document management database 520. In an illustrative embodiment of the present invention, the additional document templates can relate to documentation specific to the buyer computing device 202, the seller computing device 206 and a shipping computing device 210. At block 1814, the central processing system 204 generates transaction documents from the document templates. As explained above, in an illustrative embodiment of the present invention, the central processing system 204 generates transaction documents by merging the document templates with data specific to the particular transaction. At block 1816, the central processing system 204 transmits the transaction documents to the designated parties. In an illustrative embodiment, the central processing system 204 can transmit the transaction documents to the shipping entity 210, the seller computing device 206, and/or the buyer computing device 202. Further, the transmission of the documents can be accomplished according to a particular type of transmission medium and in a designated format. For example, the interface application 510 of the central processing system 204 can transmit the data embedded in electronic mail transmissions or as straight data transmissions. At block 1818, the central processing system 204 can also transmit notification of a completed transaction to the required entities. At block 1820, the routine 1800 terminates.

FIG. 19 is a block diagram of a screen display 1900 generated by a computing device to generate product booking information in accordance with the present invention. The screen display 1900 includes a product identification field 1902 for identifying the desired product to be transacted. The product identification may be entered directly into the user interface via an input device, such as a keyboard. Alternatively, the central processing system 204 may generate a product identifier for a pre-defined transaction. Still further, the screen display 1900 can include additional searching controls 1904 for browsing through product identifiers that may be utilized. In an illustrative embodiment of the present invention, the list of product identifiers may be filtered or otherwise ordered to assist the user in selecting an appropriate identifier. The screen display 1900 further includes a commercial information field 1906 for providing a commercial product description of the identified product. In an illustrative embodiment of the present invention, at least a portion of the commercial information field 1906 may be pre-completed with the selection of a particular product identifier. For example, commercial description information may be imported from the product management database 514 (FIG. 5).

The screen display 1900 can also include additional information fields for that may be utilized for shipping the products. In one aspect, the screen display 1900 can include a dangerous goods field 1908 for specifying whether the product will require additional certification document. In another aspect, the screen display 1900 can include a package code field 1910, number of units field 1912 and package type field 1914 for specifying the type of packing being utilized to ship products and the number of products that are being shipped within a package. The screen display 1900 can further include shipping information fields 1916 for defining more detailed aspects of the packaging, such as weight, volume, and dimensions. In an illustrative embodiment of the present invention, the central processing system 204 may assist in pre-defining at least some of the shipping information fields 1916 based on a package identification code. In a further aspect, the screen display can include a related shipping information fields 1918 that may be utilized to associate the shipping of the selected product with other products being shipped.

FIG. 20 is a block diagram illustrative of a screen display generated by a computing device to specifying carrier information for a product shipping in accordance with the present invention. The screen display 2000 includes transportation type portion 2002 for specifying what type of mode of transportation should be utilized. As illustrated in FIG. 20, the transportation type portion 2002 facilitates the selection of a limited number of transportation types. Alternatively, the transportation type portion 2002 may allow for manual entry of a transportation type. The screen display 2000 also includes a carrier identification field 2004 for specifying a particular carrier. In an illustrative embodiment of the present invention, the carrier identification may be entered directly into the user interface via an input device, such as a keyboard. Alternatively, the central processing system 204 may generate a carrier identifier that has previously been selected by a user. For example, a user may specify that a particular carrier should always be associated with a particular type of transaction. Accordingly, the central processing system could pre-define the carrier identification fields 2004 with the selected carrier information. Still further, the screen display 2000 can include additional searching controls 2006 for browsing through additional carrier identifiers, such as trading partners, that may be utilized. The screen display 2000 can also include a vessel identification field 2008 and a voyage/flight identification field 2010 to specify more detailed information as to how products will be shipped.

The screed display 2000 also includes a travel portion 2012 for specifying additional aspects of travel for the specified carrier and vessel. In an illustrative embodiment of the present invention, the travel portion 2012 can include one or more fields for specifying ports of origin, ports of arrival during transit and a final destination port and associated fields for specifying times for arriving/departing each port. Additionally, the central processing system 204 can further include additional tools that assist the user in calculating any appropriate dates. The screen display 2000 can also include a billing information portion 2014 for specifying a variety of billing/transaction information for the shipment.

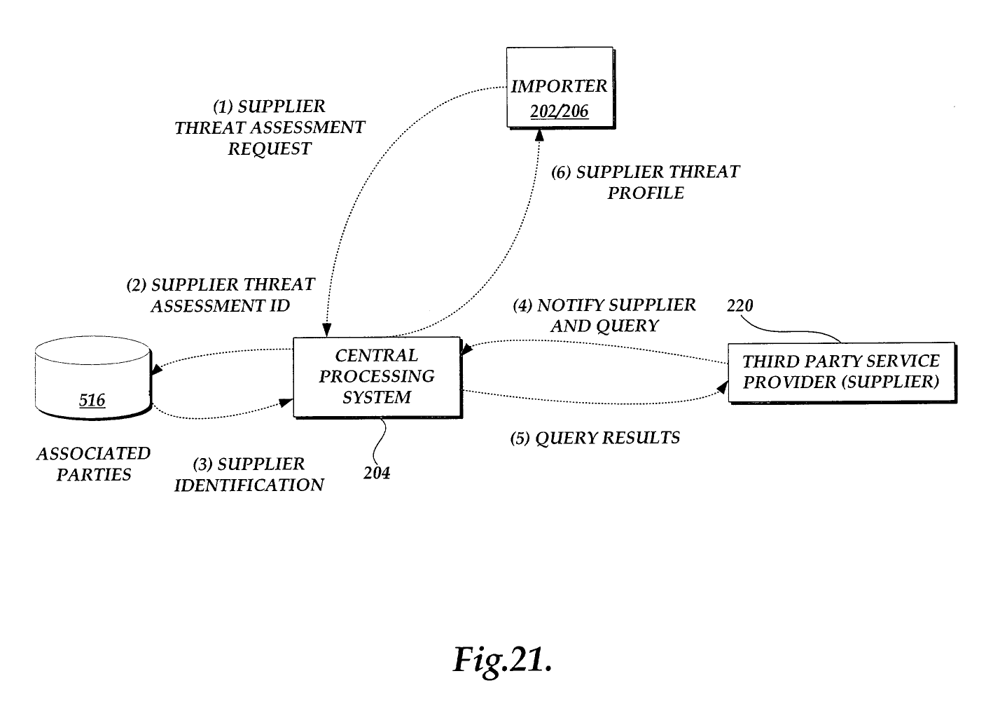

With reference now to FIG. 21, in accordance with another embodiment of the present invention, the central processing system 204 may also be utilized to generate threat profiles for one or more third party suppliers. In accordance with this embodiment, an importer, which may a buyer 202, a seller 206 or an intermediary, may have to monitor the threat profile of suppliers to satisfy governmental criteria. To facilitate this requirement, the importer transmits a profile request to the central processing system 204. The central processing system 204 obtains an identification of all the suppliers utilized by the importer by accessing the associated parties database 516.

The central processing system 204 transmits notifications to each third-party supplier 212 identified in the system. The notification can include a query for information required to generate the threat profile. In an illustrative embodiment of the present invention, the query can be an electronic form to be completed by the third party supplier. Further, the query can include a request for documentation required to complete the threat profile. Upon receiving the query results from each third-party supplier 212, the central processing system 204 processes the results and generates a supplier threat profile. In an illustrative embodiment of the present invention, the supplier threat profile includes correlating each supplier to a pre-defined threat category. Additionally, the central processing system 204 may also utilize additional data obtained from external sources to generate the threat profile. In an illustrative embodiment of the present invention, the central processing system 204 may also transmit the security threat profile to a requesting government official.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. In a system having a graphical user interface including a display and user interface selection device, a method for managing data corresponding to transactions, the method comprising:
obtaining product item data corresponding to one or more product items, wherein the product item data includes an identification of the product item, the source of the product item and at least one attribute of the product item;
generating on the display the product item data;
obtaining an action item request corresponding to the product item data;
executing the specified action item; and
displaying the results of the executed action item on the display.

2. The method as recited in claim 1, wherein the action item corresponds to a processing a query of product items matching query criteria obtained through the display, the method further comprising:
obtaining a set of product items matching the query criteria; and
displaying the set of product items on the display.

3. The method as recited in claim 2, wherein at least one attribute of the set of product items on the display includes a representation of the product item.

4. The method as recited in claim 2, wherein the action item corresponds to displaying the graphical representation of the set of product items.

5. The method as recited in claim 2 further comprising:
obtaining a selection of a subset of the set of product items matching the query criteria;
obtaining an indication of a mass update of at least one attribute of the subset of the product items matching the query criteria;
updating the at least one attribute for each product item in the subset of the product items matching the query criteria.

6. The method as recited in claim 2, wherein the action item includes the modification of one or more product item attributes.

7. The method as recited in claim 6 further comprising generating a user interface tracking product item modification, wherein the user interface includes a specification of an attribute modified, a modifier of the attribute, a previous value for the attribute and a new value for the attribute.

8. The method as recited in claim 2, wherein the search criteria are pre-defined.

9. The method as recited in claim 2, further comprising saving the search criteria in a work queue.

10. The method as recited in claim 1 wherein the action item corresponds to obtaining product item data from a supplier, the method further comprising:
identifying a set of attributes to be defined for a product item;
obtaining a set of business rules corresponding to an entry of product item data, the business rules defining acceptable values for the set of attributes;
generating one or more fields on the display, the one or more fields corresponding to the set of attributes to be defined;
obtaining input corresponding to a population of the one or more fields on the display; and
applying the business rules to the input.

11. The method as recited in claim 10, wherein the set of attributes includes a classification of the product item and wherein generating one or more fields on the display includes generating a set of acceptable classifications for selection.

12. The method as recited in claim 10, wherein the set of attributes includes a classification of the product item and wherein generating one or more fields on the display includes generating a validated choice classifications for selection.

13. A computer-readable medium having computer-executable instructions operable to perform the method recited in claim 1.

14. A method for processing transactions, the method comprising:
obtaining a request to complete a transaction;
obtaining one or more document templates corresponding to the requested transaction;
processing the document templates; and
generating one or more documents from the processing document templates.

15. The method as recited in claim 14, wherein the request to complete a transaction is a request to initiate a purchase transaction.

16. The method as recited in claim 14, wherein processing the document templates includes affixing a facsimile signature to at least one document.

17. The method as recited in claim 14, wherein the request to complete a transaction is a request to initiate a shipping order.

18. The method as recited in claim 17, wherein processing the document templates includes validating the shipping order.

19. The method as recited in claim 14 further comprising transmitting the generated documents.

20. The method as recited in claim 19, wherein transmitting the generated documents includes generating an electronic mail message including a link to the generated documents.

21. The method as recited in claim 19, wherein transmitting the generated documents includes generating a data stream including data corresponding to the generated documents.

22. The method as recited in claim 14 further comprising generating a notification of a completed transaction.

23. The method as recited in claim 14, wherein processing the document templates includes importing data corresponding to an aspect of the transaction.

24. The method as recited in claim 23, wherein the data corresponding to an aspect of the transaction includes product attribute data.

25. The method as recite in claim 23, wherein the data corresponding to an aspect of the transaction includes transaction party data.

26. The method as recited in claim 25, wherein the transaction party data is selected from a group consisting of: a buyer, a seller, a shipper, a carrier, an insurer, a financier, and logistics provider.

27. A computer-readable medium having computer-executable instructions for performing the method recited in claim 14.

28. A computer system having a processor, a memory and an operating environment, the computer system operable to perform the method recited in claim 14.

29. A system for facilitating the processing of transaction, the system comprising:
a buyer computing device operable to generate transaction requests;
a central processing system in communication with the buyer computing device and operable to process the transaction request from the buyer computing device;
a seller computing device in communication with the central processing system and operable to provide transaction information to the central processing system;
wherein the central processing system is further operable to manage the transaction information to process the transaction request.

30. The system as recited in claim 29, wherein the buyer computing device is operable to generate requests for a transaction purchase.

31. The system as recited in claim 29, wherein the buyer computing device is operable to generate requests for product items matching a search query.

32. The system as recited in claim 31, wherein the central processing system is operable to generate a graphical user interface corresponding to a listing of product items matching the search criteria.

33. The system as recited in claim 29, wherein the buyer computing device is operable to generate a request for a shipping order

34. The system as recited in claim 29, wherein the seller computing device is operable to transmit product item data to the central processing system.

35. The system as recited in claim 34, wherein the central processing system is operable to generate a graphical user interface corresponding to the transmission of product item data.
